(19) United States
(12) Patent Application Publication
(10) Pub. No.: US 2024/0383734 A1
(43) Pub. Date: Nov. 21, 2024

(54) PLATFORM, IN PARTICULAR ELEVATING PLATFORM FOR WORK AT HEIGHT

(71) Applicant: MANITOU BF, ANCENIS (FR)

(72) Inventor: Olivier CAGET, ANCENIS (FR)

(21) Appl. No.: 18/696,571

(22) PCT Filed: Aug. 18, 2022
(86) PCT No.: PCT/FR2022/051586

§ 371 Date: Mar. 28, 2024

(30) Foreign Application Priority Data
Sep. 29, 2021 (FR) 2110269

(51) Int. Cl. B66F 11/04; B66F 17/00

(52) U.S. Cl. CPC B66F 11/042; B66F 17/006

(57) ABSTRACT

A platform (1) comprising: —a self-propelled carrier (2) equipped with a drive system (3) for movement on the ground; a deck (4); —a drive device (6) for moving the deck (4) between raised and lowered positions; —at least one technical box (7) that is mounted so as to be movable between a position in which it is retracted into the carrier (2) and a position in which it is at least partially extended out of the carrier (2); —a device for manually controlling the drive device (6) for moving the deck (4) and the drive system (3) for moving the carrier (2) on the ground; —a control unit configured to control the device (6) and the system (3) according to data from the manual control device. The platform (1) comprises, for each box (7), a sensor (10) for detecting the retracted or extended position of the box (7) and the control unit is configured to control the drive system (3) for moving the carrier (2) on the ground according to data provided by the sensor (10) for detecting the position of the box (7), and to prevent the drive system (3) for moving the carrier (2) on the ground from operating when the box (7) is in an at least partially extended position.

The present invention relates to a platform, notably an elevating platform for allowing work at height.

The invention relates in particular to a platform comprising:
a so-called self-propelled chassis equipped with a system for driving movement of said chassis on the ground,
a deck having a location for receiving an operator,
a device for driving movement of the deck between a low position and a high position,
at least one technical box mounted to be movable between a position retracted into the chassis and a position at least partially extracted from the chassis in which said box extends at least partially laterally offset with respect to the chassis to allow access to the content of said box,
a device for manual control of the device for driving movement of the deck and of the system for driving the chassis on the ground,
a control unit, said control unit being configured at least to acquire data from the manual control device and to control the device for driving movement of the deck and the system for driving movement of the chassis on the ground at least as a function of the data supplied by the manual control device.

Such a platform is known as illustrated, for example, in the patents US2019/309901 or CN109502522. This platform comprises, on the chassis, at least one, generally two, technical boxes disposed side-by-side. Each technical box open at the top is a box that slides or a box that pivots for the box to transition from a position retracted in the chassis to a position at least partially extracted from the chassis in which it extends at least partially laterally with respect to the chassis. In the case of a pivoting box, said box is mounted to pivot about a so-called vertical axis, orthogonal to the plane of bearing of the chassis on the ground in the state with the chassis positioned on a horizontal flat surface. Each box is said to be technical because it notably comprises, generally, electrical or hydraulic members necessary to the correct operation of the platform. Thus, one of the boxes can contain batteries, a counter-weight, a tank, the control unit of the platform or the like, while the other box can contain hydraulic elements, such as pumps. With such boxes, the risk of accidents is increased.

One aim of the invention is to propose a platform, the design of which makes it possible to limit the risk of accidents linked to the presence of technical boxes.

One aim of the invention is to propose a platform, the design of which makes it possible to render the platform safer without compromising ease of maintenance of the platform.

To this end, the subject of the invention is a platform comprising:
a so-called self-propelled chassis equipped with a system for driving movement of said chassis on the ground,
a deck having a location for receiving an operator,
a device for driving movement of the deck between a low position and a high position,
at least one technical box mounted to be movable between a position retracted in the chassis and a position at least partially extracted from the chassis in which said box extends at least partially laterally offset with respect to the chassis to allow access to the content of said box,
a device for manually controlling the device for driving movement of the deck and the system for driving movement of the chassis on the ground,
a control unit, said control unit being configured at least to acquire data from the manual control device and to control the device for driving movement of the deck and the system for driving movement of the chassis on the ground at least as a function of the data supplied by the manual control device,
characterized in that the platform comprises, for the or each technical box, at least one sensor for detecting the retracted or extracted position of the box, and in that the control unit is configured to control the system for driving the chassis on the ground at least as a function of the data supplied by the sensor for detecting the retracted or extracted position of the box, said control unit being configured to prevent the operation of the system for driving the chassis on the ground when the or at least one of the boxes is in a position at least partially extracted from the chassis. By virtue of the fact that the control unit is configured to prevent the operation of the system for driving the chassis on the ground when the or at least one of the boxes is in a position at least partially extracted from the chassis, the result thereof is the possibility of reducing the risk of accidents in the event of an untimely extraction of the or one of the boxes. Similarly, the risk of accident is reduced during the phases of maintenance of the platform in which it may be necessary to extract the box or boxes to perform the maintenance operations inasmuch as it is not possible to control the movement of the chassis on the ground.

According to one embodiment of the invention, the device for manually controlling the device for driving movement of the deck and the system for driving the chassis on the ground comprises at least one control console borne by the deck, this control console comprising at least one manual control of the device for driving movement of the deck and one manual control for the system for driving the chassis on the ground, and the control unit is configured to allow/prohibit the control of the system for driving the chassis on the ground and the system for driving movement of the deck from the control console borne by the deck at least as a function of the data supplied by the sensor for detecting the retracted or extracted position of the box. The result thereof is a reduced risk of accidents.

According to one embodiment of the invention, the control unit is configured to prohibit any control of the system for driving the chassis on the ground and the device for driving movement of the deck from the control console borne by the deck when the box or at least one of the boxes is in a position at least partially extracted from the chassis. Thus, a risk of accident to an operator occupying the deck and resulting from an overturning of the deck because of an at least partially extracted position of the or of one of the boxes is reduced.

According to one embodiment of the invention, the chassis of the platform comprises at least one inclination sensor, the or at least one of the inclination sensors being a sensor for determining a parameter representative of an inclination of the chassis with respect to a reference plane corresponding to the plane of bearing of the chassis on the ground in the state with the chassis positioned on a horizontal flat surface, and the control unit of the device for driving movement of the deck and of the system for driving movement of the chassis on the ground is configured to acquire data from the inclination sensor or sensors and to control the device for driving movement of the deck at least as a function of the data supplied by the inclination sensor or sensors and the sensor for detecting the retracted or extracted position of the box. By virtue of this inclination sensor, it can be possible to control movement of the deck in certain conditions including in the at least partially extracted state of the or one of the boxes. This provision makes it possible to perform certain maintenance operations, such as calibrations or a change of oil in the platform elevation circuit or a monitoring of the voltage of the batteries, which require movement of the deck to be driven with the technical box or boxes in the state extracted from the chassis without compromising the safety of the operator.

According to one embodiment of the invention, the device for manually controlling the device for driving movement of the deck and the system for driving movement of the chassis on the ground comprises at least one control console capable of being borne by the chassis, this control console comprising at least one manual control of the device for driving movement of the deck and the control unit is configured to allow/prohibit the control of the system for driving movement of the deck from the control console at least as a function of the data supplied by the sensor for detecting the retracted or extracted position of the box and the inclination sensor.

According to one embodiment of the invention, the control unit is configured to prohibit any control of the device for driving movement of the deck from the control console when the box or at least one of the boxes is in a position at least partially extracted from the chassis and when the inclination sensor detects an inclination of the chassis greater than a predetermined value. Thus, it remains possible to control the device for driving movement of the deck from the control console when the or at least one of the boxes is in a position at least partially extracted from the chassis and when the inclination sensor detects an inclination of the chassis less than a predetermined value. This provision makes it possible to perform maintenance operations which require the deck to be driven in movement in total safety.

According to one embodiment of the invention, the inclination sensor is an accelerometer borne by the chassis. This provision allows for easy and safe control.

According to one embodiment of the invention, the platform comprises at least one device for emitting an alert signal and the control unit is configured to control the device for emitting an alert signal at least as a function of the data supplied by the sensor for detecting the retracted or extracted position of the box. Generally, the control unit is configured to control the emission by the system for emitting an alert signal when the or at least one of the boxes is in an at least partially extracted position.

### BRIEF DESCRIPTION OF THE DRAWINGS

The invention will be well understood on reading the following description of exemplary embodiments, with reference to the attached drawings in which:

FIG. 1 represents a perspective view of a platform according to the invention with the deck in high position;

FIG. 2 represents a side view of a platform according to the invention with the deck in low position;

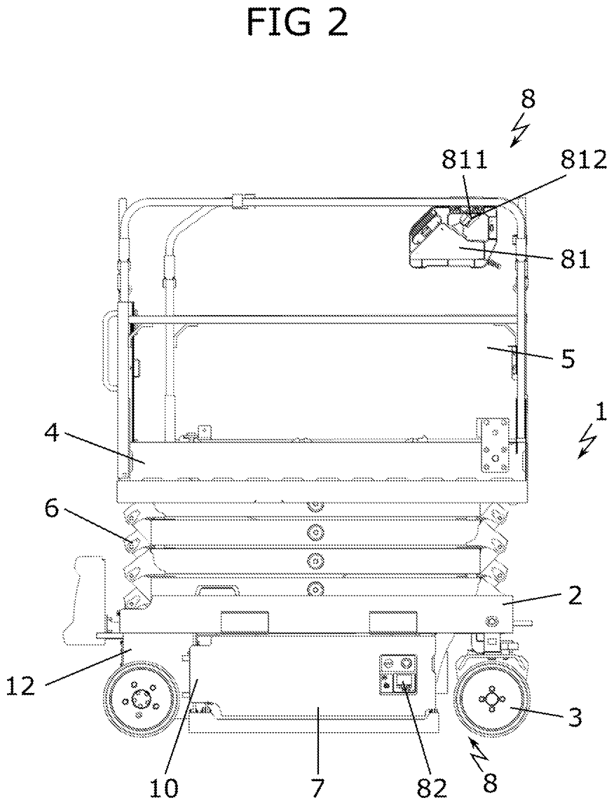

FIG. 3 represents a perspective view of the chassis of a platform according to the invention with one of the boxes in a position at least partially extracted from the chassis;

FIG. 4 represents a perspective view of the chassis of a platform according to the invention with one of the boxes in a position retracted from the chassis;

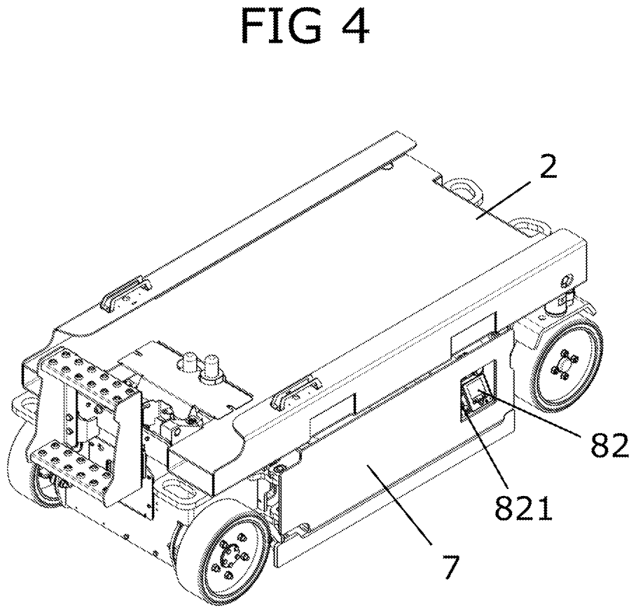

FIG. 5 represents a rear view of a chassis to illustrate the inclination sensor;

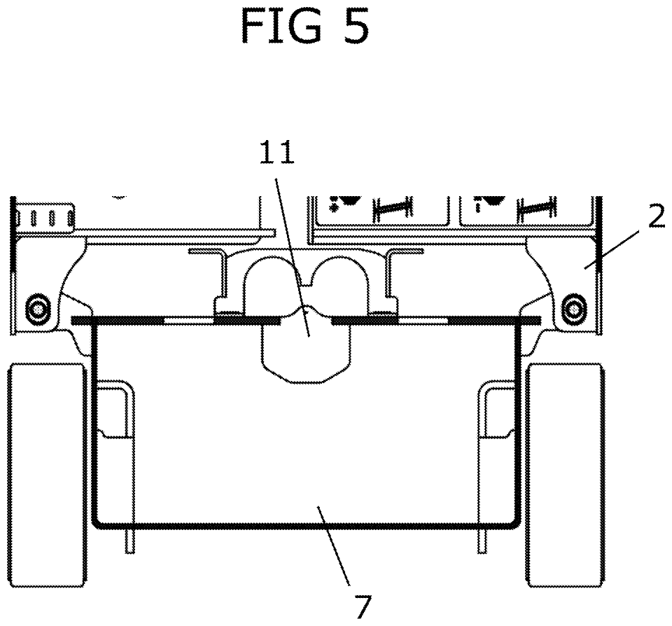

FIG. 6 represents a simplified view of the control unit with its inputs and outputs.

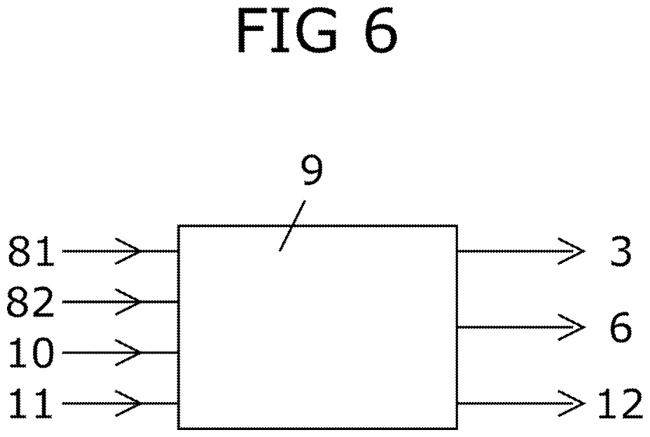

As mentioned above, the subject of the invention is a platform 1 allowing a person to work at height. This platform comprises a so-called self-propelled, that is to say motorized, chassis 2, equipped with a motor system 3 for driving movement of the chassis 2 on the ground.

The self-propelled chassis 2 is preferably a rolling chassis 2 of which at least some of the wheels are drive wheels. In the example represented, the chassis 2 is equipped with four wheels. Instead of wheels, the chassis 2 could be equipped with tracks or other members for driving movement of the chassis 2 on the ground, without departing from the scope of the invention.

The system 3 for driving movement of the chassis 2 on the ground therefore comprises one or more motors. Thus, as mentioned above, one or more wheels of the chassis 2 are drive wheels.

In the example represented, the drive wheels are wheels linked to an electric motor incorporated in the chassis 2. Likewise, certain wheels are steering wheels, having an orientation that is variable with respect to the chassis 2, to allow the platform 1 to be directed.

The electric motor or motors can be replaced by a heat engine linked to the wheels via a transmission, preferably hydrostatic, which can comprise a hydrostatic pump and hydraulic motors each associated with a so-called drive wheel.

The detail of this transmission will not be described in detail, because such a transmission is well known to those skilled in this art.

Similarly, the system 3 for driving movement of the chassis 2 on the ground will not be described in detail, because it is well known to those skilled in this art.

The platform 1 also comprises a deck 4 having a location 5 for receiving an operator.

This working deck 4 is, here, formed by a floor, and guard rails surrounding the floor while allowing access to the interior of said deck.

The interior of the deck 4 delimited by the guard rail therefore forms the location 5 for receiving an operator of the deck 4. The operator is generally standing in the location 5 for receiving the deck 4.

The platform 1 also comprises a device 6 for driving movement of the deck 4 disposed at least partially between the chassis 2 and the deck 4, for the deck 4 to transition from a low position to a high position and vice versa.

This device 6 for driving movement of the deck 4 can take on a large number of forms.

Thus, the deck 4 can be linked to the chassis 2 by an elevation structure comprising at least one actuator of the elevation structure. Actuator and elevation structure form at least a part of the device 6 for driving movement of the deck 4.

The elevation structure can comprise at least one arm pivoting about a horizontal axis, and the actuator is an actuation cylinder of said arm extending between the arm and the chassis.

This arm can be a telescopic arm.

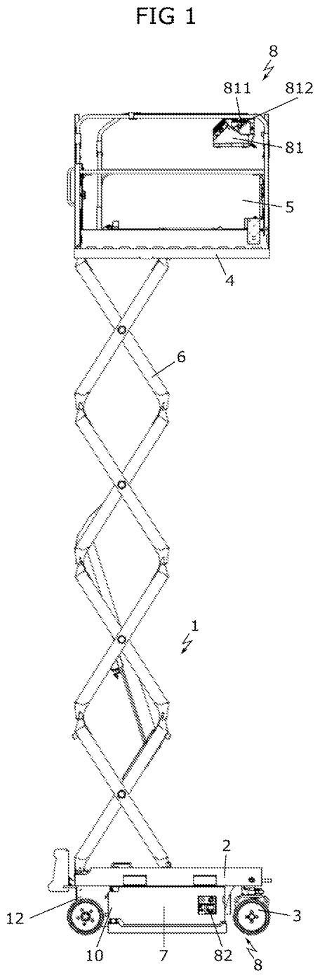

As a variant, and as in the example represented in FIG. 1, the elevation structure can be a structure of scissor type and the actuators such as cylinders can be provided to drive the movement of the scissors.

The platform 1 comprises at least one technical box 7 mounted to be movable between a position retracted in the chassis 2 and a position at least partially extracted from the chassis 2, in which said box 7 extends at least partially laterally offset with respect to the chassis 2, to allow access to the content of the box 7.

In the example represented, the chassis 2 takes on, when seen from above, a quadrangular form, in particular a rectangular form.

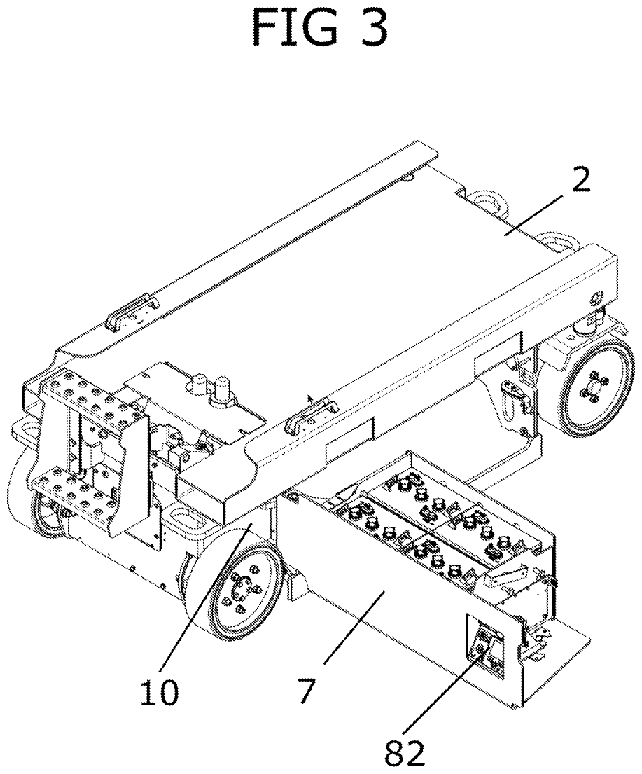

This chassis 2 takes the form of a block, inside which is formed a space for receiving the box or boxes. This chassis 2 has two edges that are longitudinal when taken with reference to the longitudinal axis of the chassis 2 which extends from a front end toward a rear end of the chassis 2. The boxes 7, of which there are two here, extend in a position at least partially extracted from the chassis 2, protruding from a longitudinal edge of the chassis 2, as illustrated in FIG. 3, with one of the boxes which protrudes from one of the longitudinal edges of the chassis and the other box which protrudes from the other longitudinal edge of the chassis 2. Obviously, the invention applies equally to a chassis 2 equipped with a single box.

Each box 7 is open at the top, to allow access to the interior of the box, in an at least partially extracted position.

Each box 7 is said to be technical, because it houses elements or members that are necessary to the correct operation of the platform, such as batteries, pumps, a fluid tank or the like.

Once again, the content of these technical boxes 7 will not be described in detail, because it is well known to those skilled in this art, and is of little importance in the context of the present invention.

Each technical box 7 can, for its transition from one position to another, be a sliding or pivoting box. It is the second solution which is represented in FIG. 3, in which the box pivots about a so-called vertical axis, extending vertically in the state with the chassis 2 positioned on a horizontal flat surface.

The platform 1 also comprises a manual control device 8, that is to say with manual actuation of the device 6 for driving movement of the deck 4 and of the system 3 for driving movement of the chassis 2 on the ground.

In the examples represented, the manual control device 8 of the device 6 for driving movement of the deck 4 and of the system 3 for driving the chassis 2 on the ground comprises at least one control console 81 borne by the deck 4.

This control console 81 comprises at least one manual control 811, that is to say one that can be actuated by the operator of the device 6 for driving movement of the deck 4 and a manual control 812, that is to say one that can be actuated by the operator of the system 3 for driving the chassis 2 on the ground.

This control console 81 is generally disposed away from the floor of the deck, along the guard rail of the deck, as illustrated in FIG. 1.

The manually actuatable controls 811, 812 of the control console 81 can be formed by buttons, levers or other such means. The manual control 811 of the device 6 for driving movement of the deck 4 makes it possible, on the deck 4, from the control console 81, to control the device 6 for driving movement of the deck 4 by actuation of at least one actuator of the elevation structure, to allow a raising and lowering movement of the deck.

The manual control 812 of the system 3 for driving the chassis on the ground makes it possible, on the deck 4, from the control console 81, to control the system 3 for driving movement of the chassis 2 on the ground by controlling one or more motors.

In the example represented, the manual control device 8 of the device 6 for driving movement of the deck 4 and of the system 3 for driving movement of the chassis 2 on the ground further comprises at least one control console 82 that can be borne by the chassis 2.

This control console 82 comprises at least one manual control 821 of the device 6 for driving movement of the deck 4.

In the example represented, this control console 82 is installed along a side of the chassis, on the face of one of the technical boxes 7.

Once again, the manual control 821, that is to say the control with manual actuation, of the device 6 for driving movement of the deck 4, in particular in raising and lowering of the deck 4, can be formed by a lever, a button or other such means.

To allow a control of the device 6 for driving movement of the deck 4 and of the system 3 for driving movement of the chassis 2 on the ground as a function of the data supplied by the manual control device 8 of the device 6 for driving movement of the deck 4 and of the system 3 for driving movement of the chassis 2 on the ground, the platform 1 comprises a control unit 9.

Said control unit 9 takes the form of an electronic and computing system which comprises, for example, a microprocessor and a working memory. According to a particular aspect, the control unit can take the form of a programmable logic controller. In other words, the functions and steps described can be implemented in computer program form or via hardware components (for example programmable gate arrays). In particular, the functions and steps operated by the control unit or its modules can be performed by instruction sets or computing modules implemented in a processor or controller or be performed by dedicated electronic components or components of programmable logic circuit (or FPGA, the acronym for field-programmable gate array) type, or of application-specific integrated circuit (or ASIC) type. It is also possible to combine computing parts and electronic parts.

When it is specified that the unit or means or modules of said unit are configured to perform a given operation, that means that the unit comprises computing instructions and corresponding execution means which make it possible to perform said operation and/or that the unit comprises corresponding electronic components. Said control unit 9 is therefore configured to acquire data from the manual control device 8 and to control the device 6 for driving movement of the deck 4 and the system 3 for driving movement of the chassis 2 on the ground at least as a function of the data supplied by the manual control device 8.

To perfect the platform 1, the latter comprises a sensor 10 for detecting the retracted or extracted position of the box 7 for each technical box 7 with which said platform is equipped.

This sensor 10 for detecting the position of each box can for example be an inductive sensor mounted on the chassis or the box 7.

It should be noted that each technical box 7 can be held in position retracted inside the chassis 2 using a lock that can be manually actuated by the operator. Such a lock can limit the risks of untimely extraction of the associated box.

The control unit 9 is configured to control the system 3 for driving the chassis 2 on the ground at least as a function of the data supplied by the sensor 10 for detecting the retracted or extracted position of the box 7, said control unit 9 being configured to prevent the operation of the system 3 for driving the chassis 2 on the ground when the or at least one of the boxes 7 is in a position at least partially extracted from the chassis 2.

Thus, as soon as a box is detected as being in an at least partially extracted position, the operator can no longer control a movement of the platform on the ground, the data supplied by the manual control device 8 no longer being transmitted via the control unit 9 to the system 3 for driving movement of the chassis 2 on the ground regardless of the origin of these data, supplied by the manual control device 8, namely whether these data are from the control console 81 or from the control console 82.

Furthermore, the control unit 9 is configured to allow/prohibit the control of the device 6 for driving movement of the deck 4 from the control console 81 borne by the deck 4, at least as a function of the data supplied by the sensor 10 for detecting the retracted or extracted position of the box 7.

In particular, the control unit 9 is configured to prohibit any control of the device 6 for driving movement of the deck 4, from the control console 81 borne by the deck 4, when the box 7 or at least one of the boxes 7 is in a position at least partially extracted from the chassis 2.

It is thus impossible to control the movement of the chassis 2 or of the deck 4 using the control console 81 when the or at least one of the boxes 7 is in a position at least partially extracted from the chassis 2.

This provision reinforces the safety and limits the risks of toppling and overturning of the platform 1 when an operator is present on the deck 4.

The chassis 2 of the platform also comprises at least one inclination sensor 11. In the example represented, a single inclination sensor 11 is represented, but the platform 1 could have been able to include several, without departing from the scope of the invention.

This inclination sensor 11 is a sensor for determining a parameter representative of an inclination of the chassis 2 with respect to a reference plane corresponding to the plane of bearing of the chassis 2 on the ground, in the state with the chassis 2 positioned on a horizontal flat surface.

In the examples represented, this inclination sensor 11 is an accelerometer borne by the chassis 2. This accelerometer makes it possible to detect an inclination of the chassis with respect to a reference horizontal plane, in the front/rear or left/right direction of the chassis 2.

The control unit 9 of the device 6 for driving movement of the deck 4 and of the system 3 for driving movement of the chassis 2 on the ground is configured to acquire data from the inclination sensor or sensors 11 and to control the device 6 for driving movement of the deck 4, at least as a function of the data supplied by the inclination sensor or sensors 11 and the sensor 10 for detecting the retracted or extracted position of the box 7.

In particular, the control unit 9 is configured to allow/prohibit the control of the device 6 for driving movement of the deck 4 from the control console 82 at least as a function of the data supplied by the sensor 10 for detecting the retracted or extracted position of the box 7 and the inclination sensor 11.

Thus, said control unit 9 is configured to prohibit any control of the device 6 for driving movement of the deck 4 from the control console 82, when the box 7 or at least one of the boxes 7 is in a position at least partially extracted from the chassis 2 and when the inclination sensor 11 detects an inclination of the chassis 2 greater than a predetermined value.

Indeed, when the or one of the boxes 7 is in a position at least partially extracted from the chassis 2 and when the inclination sensor 11 detects an inclination of the chassis 2 greater than a stored predetermined inclination value, the operator can actuate the manual control device 8 of the device for driving movement of the deck 4 and of the system 3 for driving movement of the chassis 2 on the ground, but the data supplied by this manual control device 8 are not transmitted by the control unit 9 to the device 6 for driving movement of the deck 4 and to the system 3 for driving movement of the chassis 2 on the ground, such that any movement is impossible.

In order to alert the operator to an extraction of the or at least one of the boxes 7, the platform 1 comprises at least one device for emitting an alert signal 12, and the control unit 9 is configured to control the device for emitting an alert signal 12 at least as a function of the data supplied by the sensor 10 for detecting the retracted or extracted position of the box 7.

In particular, the control unit 9 is configured to control the emission of an alert signal 12 which can be an auditory or visual signal, when the at least partially extracted position of the box 7 is detected.

It emerges from the above that as soon as a box is detected in an at least partially extracted position, any driving of the movement of the chassis 2 on the ground and any raising and lowering movement of the deck 4 controlled from the control console are prevented.

Furthermore, as soon as a box 7 is detected in an at least partially extracted position, any driving of the chassis in movement on the ground controlled from the control console is prevented, and a raising and lowering movement of the deck controlled from the control console is allowed only if the inclination sensor detects an inclination of the chassis with respect to the reference plane that is less than a predetermined value.

1. A platform (1) comprising:
a so-called self-propelled chassis (2) equipped with a system (3) for driving movement of said chassis (2) on the ground,
a deck (4) having a location (5) for receiving an operator,
a device (6) for driving movement of the deck (4) between a low position and a high position,
at least one technical box (7) mounted to be movable between a position retracted in the chassis (2) and a position at least partially extracted from the chassis (2) in which said box (7) extends at least partially laterally offset with respect to the chassis (2) to allow access to the content of said box (7),
a device (8) for manually controlling the device (6) for driving movement of the deck (4) and the system (3) for driving movement of the chassis (2) on the ground,
a control unit (9), said control unit (9) being configured at least to acquire data from the manual control device (8) and to control the device (6) for driving movement of the deck (4) and the system (3) for driving movement of the chassis (2) on the ground at least as a function of the data supplied by the manual control device (8),
characterized in that the platform (1) comprises, for the or each technical box (7), at least one sensor (10) for detecting the retracted or extracted position of the box (7), and in that the control unit (9) is configured to control the system (3) for driving the chassis (2) on the ground at least as a function of the data supplied by the sensor (10) for detecting the retracted or extracted position of the box (7), said control unit (9) being configured to prevent the operation of the system (3) for driving the chassis (2) on the ground when the or at least one of the boxes (7) is in a position at least partially extracted from the chassis (2).

2. The platform (1) as claimed in claim 1, characterized in that the manual control device (8) of the system (6) for driving movement of the deck (4) and of the system (3) for driving the chassis (2) on the ground comprises at least one control console (81) borne by the deck (4), this control console (81) comprising at least one manual control (811) of the device (6) for driving movement of the deck (4) and a manual control (812) of the system (3) for driving the chassis (2) on the ground, and in that the control unit (9) is configured to allow/prohibit the control of the system (3) for driving the chassis (2) on the ground and of the device (6) for driving movement of the deck (4) from the control console (81) borne by the deck (4) at least as a function of the data supplied by the sensor (10) for detecting the retracted or extracted position of the box (7).

3. The platform (1) as claimed in claim 2, characterized in that said control unit (9) is configured to prohibit any control of the system (3) for driving the chassis (2) on the ground and of the device (6) for driving movement of the deck from the control console borne by the deck (4) when the box (7) or at least one of the boxes (7) is in a position at least partially extracted from the chassis (2).

4. The platform (1) as claimed in one of claims 1 to 3, characterized in that the chassis (2) of the platform (1) comprises at least one inclination sensor (11), the or at least one of the inclination sensors (11) being a sensor for determining a parameter representative of an inclination of the chassis (2) with respect to a reference plane corresponding to the plane of bearing of the chassis (2) on the ground in the state with the chassis positioned on a horizontal flat surface, and in that the control unit (9) of the device (6) for driving movement of the deck (4) and of the system (3) for driving movement of the chassis (2) on the ground is configured to acquire data from the inclination sensor or sensors (11) and to control the device (6) for driving movement of the deck (4) at least as a function of the data supplied by the inclination sensor or sensors (11) and the sensor (10) for detecting the retracted or extracted position of the box (7).

5. The platform (1) as claimed in claim 4, characterized in that the manual control device (8) of the device (6) for driving movement of the deck (4) and of the system (3) for driving movement of the chassis (2) on the ground comprises at least one control console (82) capable of being borne by the chassis (2), this control console (82) comprising at least one manual control (821) of the device (6) for driving movement of the deck (4) and in that the control unit (9) is configured to allow/prohibit the control of the device (6) for driving movement of the deck (4) from the control console (82) at least as a function of the data supplied by the sensor (10) for detecting the retracted or extracted position of the box (7) and the inclination sensor (11).

6. The platform (1) as claimed in claim 5, characterized in that said control unit (9) is configured to prohibit any control of the device (6) for driving movement of the deck (4) from the control console (82) when the box (7) or at least one of the boxes (7) is in a position at least partially extracted from the chassis (2) and when the inclination sensor (11) detects an inclination of the chassis (2) greater than a predetermined value.

7. The platform (1) as claimed in one of claims 4 to 6, characterized in that the inclination sensor (11) is an accelerometer borne by the chassis.

8. The platform (1) as claimed in one of claims 1 to 7, characterized in that the platform (1) comprises at least one device for emitting an alert signal (12) and in that the control unit (9) is configured to control the device for emitting an alert signal (12) at least as a function of the data supplied by the sensor (10) for detecting the retracted or extracted position of the box (7).
